(19) United States
(12) Patent Application Publication
(10) Pub. No.: US 2022/0113413 A1
(43) Pub. Date: Apr. 14, 2022

(54) DISTANCE MEASUREMENT WITH A LIGHT TIME OF FLIGHT METHOD

(71) Applicant: SICK AG, Waldkirch (DE)

(72) Inventors: Ulrich ZWÖLFER, Waldkirch (DE); Michael ALBERT, Waldkirch (DE); Stephan KOLB, Waldkirch (DE)

(21) Appl. No.: 17/498,396

(22) Filed: Oct. 11, 2021

(30) Foreign Application Priority Data
Oct. 13, 2020 (DE) 102020126799.1

(51) Int. Cl. G01S 17/10; G01S 7/4863; G01S 7/4865; G01S 7/487

(52) U.S. Cl. CPC G01S 17/10; G01S 7/487; G01S 7/4865; G01S 7/4863

(57) ABSTRACT

An optoelectronic sensor for measuring a distance using a light time of flight method, comprising a light transmitter for transmitting a light signal, a light receiver having a plurality of light receiving elements for detecting received light, a plurality of light time of flight measuring units for determining respective individual light times of flight, a memory for collecting individual light times of flight, and a control and evaluation unit configured to determine a distance value by evaluating the collected individual light times of flight, wherein a readdressing unit is configured to write individual light times of flight to specific addresses of a same uniform memory depending on the assignment of a light time of flight measuring unit to a group, so that the control and evaluation unit can assign the stored individual light times of flight via the address to a group and thus to a distance value.

The invention relates to an optoelectronic sensor and a method for measuring the distance of an object in a detection area using a light time of flight method.

Distance sensors based on the light time of flight principle measure the time of flight of a light signal, which corresponds to the distance using the speed of light. A distinction is made between pulse-based and phase-based measurement. In a pulse time of flight method, a short light pulse is transmitted and the time until a reception of a remission or reflection of the light pulse is measured. Alternatively, in a phase method, transmitted light is amplitude modulated and a phase shift between transmitted and received light is determined, wherein the phase shift is also a measure of the light time of flight.

Avalanche photodiodes (APD) are used in some optoelectronic sensors in order to be able to also detect low received intensities. The incident light triggers a controlled avalanche effect. As a result, the charge carriers generated by the incident photons are multiplied, and a photocurrent is generated that is proportional to the received light intensity, but much larger than with a simple PIN diode.

Even greater sensitivity is achieved with avalanche photodiodes operated in the so-called Geiger mode (SPAD, Single Photon Avalanche Diode). Here, the avalanche photodiode is biased above the breakdown voltage, so that even a single charge carrier released by a single photon can trigger an uncontrolled avalanche, which then recruits all available charge carriers due to the high field strength. The avalanche then comes to a standstill (passive quenching) and is no longer available for detection for a certain dead time. Alternatively, it is also known to detect the avalanche from the outside and to extinguish it (active quenching).

A SPAD thus counts individual events like a Geiger counter. SPADs are not only highly sensitive, but also comparatively inexpensive and efficient to integrate in silicon semi-conductors. Furthermore, they can thus be integrated on a circuit board with little effort. A peculiarity is the fact that even a minimal interference event, such as an extraneous light photon or dark noise, generates the same maximum received signal as a useful light signal.

A distance sensor based on SPADs preferably works pulse-based to ensure robust measurements even in the case of edge hits or remission jumps. This is also referred to as direct time of flight (dToF) measurement. In order to obtain reliable measurement results despite interference, events can be collected over several SPADs or several transmission pulses and evaluated together by searching for a maximum in a histogram.

For the practical implementation of this solution, a histogram memory must be provided. To this end, a memory compiler generates an area-optimized function block for a certain memory size, such as 1024×10 bits, and preferably extends it with a BIST (Built In Self Test) for testability. This fixes the system to a histogram having a fixed resolution of at most 1024 bins.

For some sensors, however, it is desired to measure the distance to a plurality of points or measurement areas (ROI, region of interest). Using a fixed histogram memory, such a multi-segment evaluation can only be realized sequentially. Alternatively, a separate histogram memory would have to be provided for the maximum number of possible measurement areas with significantly increased area consumption and increased chip costs.

In principle, it would also be conceivable to divide the one existing histogram memory for several measuring ranges, accepting losses in resolution, and for example to use four histograms with 256 bins instead of one histogram with 1024 bins. However, four histogram memories partitioned in this way, including addressing logic and the like, consume considerably more space than a single larger histogram memory. In addition, the partitioning would be fixed; only four lower-resolution histograms could then be recorded, but not one high-resolution histogram. Merging memory blocks into one larger memory block also requires addressing logic and consumes area. These considerations play an important role especially for structures in the order of 100 nm, and with the usual quantities for opto-ASICs and similar digital components used in optoelectronic sensors, smaller structures are hardly affordable.

EP 2 475 957 B1 discloses an optical distance measurement device based on SPADs. Groups of SPADs are formed and used to measure light times of flight. By forming groups, the light time of flight measurement is intended to respond to the special nature of SPADs, since interfering individual events are levelled due to the group. Histograms are not formed, however, so that the problem of storing multiple histograms does not arise in the first place.

Another optoelectronic sensor is known from EP 3 428 683 B1, which measures distances using SPADs and a dToF method. A switch matrix is provided to select specific SPADs for evaluation and to connect them one-to-one with TDCs (time-to-digital converters). A single common histogram is collected with these selected SPADs. In EP 3 454 086 B1, such a selection of SPADs is used to determine multiple distance values to align a positioning system. The document explains the selection of SPADs from several measurement ranges, but not the detailed implementation of the required multiple evaluation, and not even the term histogram is mentioned.

It is therefore an object of the invention to obtain additional measurement information in an improved manner using a sensor based on a direct time of flight method.

This object is satisfied by an optoelectronic sensor for measuring a distance of an object in a detection area using a light time of flight method, the sensor comprising a light transmitter for transmitting a light signal into the detection area, a light receiver having a first plurality of light receiving elements for detecting received light from the detection area, a second plurality of light time of flight measuring units for determining respective individual light times of flight from a light time of flight between transmission of the light signal and reception of the light signal remitted or reflected at the object, a memory for collecting individual light times of flight, and a control and evaluation unit configured to determine a distance value by evaluating the collected individual light times of flight, including the possibility to determine at least two distance values from the individual light times of flight of at least two groups of light time of flight measuring units, wherein the sensor comprises a readdressing unit configured to write individual light times of flight to specific addresses of a same uniform memory depending on the assignment of a light time of flight measuring unit to a group, so that the control and evaluation unit can assign the stored individual light times of flight via the address to a group and thus to a distance value.

The object is also satisfied by a method for a distance measurement of an object in a detection area using a light time of flight method, wherein a light signal is transmitted into the detection area and the light signal reflected or remitted in the detection area is detected by a light receiver having a first plurality of light receiving elements, wherein respective individual light times of flight are measured with a second plurality of light time of flight measuring units from a light time of flight between transmitting the light signal and receiving the light signal remitted or reflected at the object, the individual light times of flight are collected in a memory, and at least two distance values are determined from the individual light times of flight of at least two groups of light time of flight measuring units, wherein individual light times of flight are written to specific addresses of the same uniform memory depending on the assignment of a light time of flight measuring unit to a group and, when distance values are determined, the stored individual light times of flight are assigned via the address to a group and thus to a distance value.

A light signal is transmitted with at least one light transmitter, and the light signal returning from the detection area is registered in a light receiver. The light receiver comprises a first plurality of light receiving elements or pixels arranged, for example, in a matrix. Individual ones or groups of the light receiving elements are each connected to a light time of flight measuring unit, which measures an individual light time of flight of the light signal of the connected light receiving element or elements. In total, there is a second plurality of light time of flight measuring units which preferably is smaller than the first plurality of light receiving elements. This means that only a part or even a small part of the light receiving elements are selected in active measuring areas of the light receiver. The individual light times of flight are collected or accumulated in a memory, and a control and evaluation unit generates a distance value from the collected individual light times of flight. The sensor provides the possibility of determining at least two distance values from the individual light times of flight of at least two groups of light time of flight measuring units. Thus, depending on the number of groups, there are multiple measurement areas (ROI, region of interest) for each of which a distance value is measured simultaneously. In some embodiments, the sensor is switchable and, in addition to the simultaneous determination of multiple distance values, also offers a mode with only a single group, thus a single measuring range.

The invention starts from the basic idea of using the same memory for collecting the individual light times of flight even for a multiple evaluation with a plurality of measuring ranges and associated groups of light transit time measuring units. Thus, there still is only one single physical memory with uniform addressing over the entire memory, in particular only a single function block generated by a memory compiler. A readdressing unit ensures that the individual light times of flight are each written to an address in the memory that depends on the light time of flight measuring unit measuring the individual light time of flight and from which address the assignment to a group can be reconstructed. The assignment to a group and thus to a measuring range is thus coded in the address. Therefore, the memory is functionally partitioned, because the content of a memory cell is assigned to a particular group via its address. In its physical implementation, however, the memory still is a uniform and non-partitioned memory.

The invention has the advantage that multiple distance values can be obtained from multiple measurement areas while only consuming a small chip area, thus reducing manufacturing costs. It is no longer necessary to carry out multiple measurements one after the other in order to cope with using only one memory. It is therefore possible to have both short measurement times and low cost. Processing multiple groups in the same memory means a loss of resolution, and it is a matter of application to make an appropriate choice of multiple measuring ranges and suitable resolution.

The control and evaluation unit preferably is configured to change the number of groups. Throughout this specification, the terms preferably or preferred refer to advantageous, but completely optional features. The readdressing unit ensures that the individual light times of flight are stored at addresses of the memory according to the new number of groups, from which the new group membership of the light time of flight measuring units can be reconstructed. The number of measuring ranges can thus be adapted to the needs of an application. The changeover can be done by configuration or programming and is even possible dynamically during operation. As already mentioned, it is also possible to switch to only one group. This is because the functional division of the uniform memory into several groups results in a loss of resolution, so that it can indeed be interesting to measure with only one group at the highest possible resolution.

The sensor preferably comprises a selection unit configured to variably connect light time of flight units to light receiving elements. This does not only provide flexibility as to how the light time of flight units are divided into groups, i.e. which pixels are combined into one respective distance measurement value. It also becomes selectable to which pixel on the light receiver light time of flight units are assigned, thus allowing the location of the measurement areas (ROIs) to be fixed or changed. As a rule, it makes sense to associate a neighborhood of pixels with light time of flight units of the same group. In principle, however, the assignment is not restricted, and a group may also consist of pixels distributed over the light receiver. For example, it may be useful to cover a measurement area with a grid of only every i^{th} pixel connected to a light time of flight measurement unit, in order to scan a larger area with few light time of flight measurement units. The selection unit is preferably a switch matrix.

The memory preferably is configured so that a discrete function can be stored therein in memory cells with successive addresses, and individual light times of flight can be stored therein and retrieved in this way, wherein in particular the addresses of the memory cells correspond to the definition range and the associated function values are stored in the memory cells. In other words, the memory is organized such that the addresses correspond to the X values and the contents of the memory cells correspond to the Y values of a discrete function. Of course the definition range in general is offset and rescaled compared to the adresses: For example, adresses 0, 1, . . . 15 correspond to time values 15 ns, 30 ns, . . . 240 ns by multiplying by 15 ns and shifting by +15 ns. Similar shifting and rescaling may apply to the contents of the memory cells, unless they are used as counters only.

The readdressing unit preferably is configured to use at least one address bit of an address for assignment to a group. The at least one repurposed address bit no longer codes for an X-value, but for the group or the measuring range. With s address bits repurposed in this way, the memory is functionally divided into 2^{s} partial memory areas. At the same time, the X resolution is reduced by a factor of 1/2^{s}. Preferred cases are s=1 with two partial memory areas at half the resolution and s=2 with four partial memory areas at a quarter of the resolution. The case s=0 preferably remains selectable, resulting in only one measuring range at highest resolution. At first glance, only a number of measuring ranges corresponding to a power of two is possible. However, other numbers can also be implemented by leaving partial memory areas unused or by the control and evaluation unit combining several partial memory areas into one distance measurement value.

The repurposed address bit used for assignment to a group preferably is the most significant bit (MSB), or the repurposed address bits are the most significant bits. This has the advantage that all individual light times of flight of one and the same group are stored at consecutive addresses. If other bits are used, which is also conceivable in principle, the information would be distributed over the memory to addresses separated from each other. This makes the later evaluation and distance value calculation more complicated.

The memory preferably is configured as a histogram memory, and the individual light times of flight are collected in at least one histogram. A histogram is a discretization of a frequency distribution and a special case of a function stored in the memory and is particularly suitable for summarizing the measurement information of the individual light times of flight. An address in the memory corresponds to a bin of the histogram, where the bins discretize time, and the content of the respective memory cell corresponds to the frequency value or count. In the case of a plurality of groups, a plurality of histograms is collected at the addresses of the memory assigned to each group.

The histogram memory preferably comprises as many memory cells as bins of a histogram for only one group. In other words, the memory is configured to be just large enough to hold a single histogram of the highest resolution. A small number of unused memory cells remains conceivable, such as when 1,000 bins are desired but 1,024 bins are more easily implemented. For a measurement with multiple measurement ranges, multiple histograms with corresponding reduced resolution are stored instead, in particular 2^{s} histograms each having 1/2^{s} of the bins and correspondingly reduced time resolution. It should be mentioned that there is of course also a second resolution on the other axis that is not meant in this context, namely the bit depth of the memory cells, which specifies the maximum frequency value or count storable in a bin.

The readdressing unit preferably is configured to encode the group in at least one bit of the addresses, in particular the most significant bit or bits, and to encode a respective bin of a histogram in the remaining bits of the addresses. The addresses are thus interpreted as two sub-blocks, with a first sub-block for the assignment to a group and a second sub-block for the bin. When a light time of flight measurement unit has determined an individual light time of flight, it is rounded to the bin width and thus assigned to a bin. This can be implemented particularly easily if bits of the measured individual time of flight are directly interpreted as address bits of the second sub-block. Depending on the number of groups, the readdressing unit has provided for the lowest bits of the individual light time of flight to be ignored; this is the loss of resolution that must be accepted for the multiple simultaneously evaluated measurement ranges. Alternatively, the range of the measurement is reduced; in this case, the reduced number of bins count covers only a smaller uniqueness range of the measurement. The readdressing unit also ensures that address bits are set in the first sub-block which correspond to the assignment of the measuring time of flight measuring unit to the group. At the resulting address, the memory content is incremented by one.

The light receiving elements preferably each comprise an avalanche photodiode biased with a bias voltage above a breakdown voltage and thus operated in a Geiger mode. In distance measurement, the high sensitivity and dynamic compression of avalanche photodiode elements in Geiger mode and SPADs, respectively, is particularly advantageous. The statistical evaluation by collecting individual light times of flight, in particular in a histogram, is particularly suitable for SPADs and their peculiarities.

The light time of flight measuring units preferably comprise a TDC (time-to-digital converter). This is a well-known and relatively simple component that can determine individual light times of flight with high temporal resolution. TDCs can be directly and monolithically integrated in a crystal of the light receiver. The TDC preferably is started at the time of transmission and stopped at the time of reception by the received individual light pulse. Other modes of operation are conceivable, such as starting the TDCs each time an avalanche is triggered and then stopping them at a known time, such as the end of the measurement period.

The method according to the invention can be modified in a similar manner and shows similar advantages. Further advantageous features are described in an exemplary, but non-limiting manner in the dependent claims following the independent claims.

The invention will be explained in the following also with respect to further advantages and features with reference to exemplary embodiments and the enclosed drawing. The

Figures of the drawing show in:

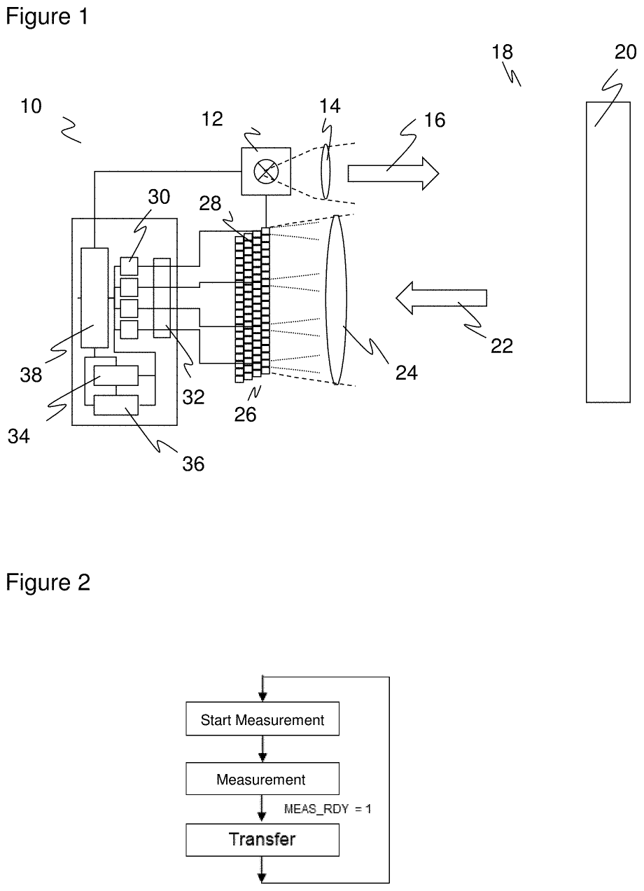

FIG. 1 a schematic block diagram of an optoelectronic sensor

FIG. 2 an illustration of the general measuring process;

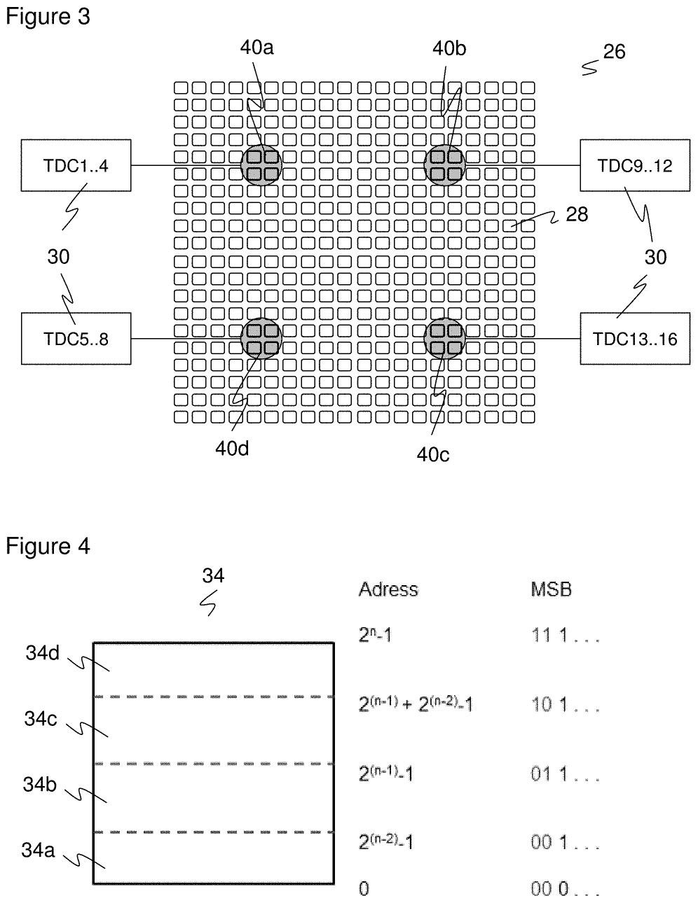

FIG. 3 an illustration of an exemplary assignment of measuring ranges (ROIs) to time of flight measuring units;

FIG. 4 an illustration of an exemplary addressing of a histogram memory that is used for multiple measurement areas (ROIs); and

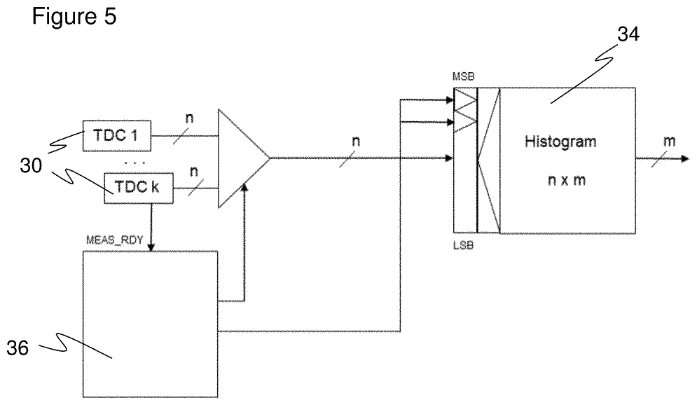

FIG. 5 an illustration of an exemplary interconnection of time of flight measuring units, readdressing unit, and histogram memory.

FIG. 1 shows a simplified schematic block diagram of an optoelectronic sensor 10 for distance measurement. A light transmitter 12, for example an LED or a laser light source, transmits a light signal 16 into a detection area 18 via transmitter optics 14. The light transmitter 12 is shown as an external component but may also be an integral part of the sensor 10. The transmitted light signal 16 preferably comprises a light pulse, the sensor 10 measuring distances according to the pulse method or a direct time of flight (dToF) method. Preferably, short light pulses of a few 100 ps are generated.

When the light signal 16 impinges on an object 20 in the detection area 18, a remitted or reflected light signal 22 returns to a light receiver 26 via receiving optics 24. The light receiver 26 has a plurality of light receiving elements, preferably avalanche photodiode elements 28 in Geiger mode or SPADs, which may be construed as pixels. SPADs provide a virtually digital signal and thus respond exceptionally quickly to incoming light.

The received signals from selected avalanche photodiode elements 28 are read and evaluated by light time of flight measurement units 30. Shown are only four time of flight light measurement units 30, in practice there are usually more, for example of the order of ten, but significantly fewer than avalanche photodiode elements 28, of which there are typically hundreds, thousands or even significantly more. The light time of flight measuring units 30, which in particular each comprise a TDC (time-to-digital converter) with a time resolution of, for example, 100 ps, each measure a light time of flight from transmission of the light signal 16 to reception of the returning light signal 22. It is also conceivable not to leave it at an individual light time of flight determination, but to determine the light times of flight to several reception events, in particular by the TDC continuing to run after buffering the detected light time of flight. This provides a multi-echo capability which may be useful, for example, for measurements through semi-transparent objects or glass panes, measurements in the presence of contamination by dust, and the like.

A selection unit 32, for example in the form of a switch matrix, is arranged between the light receiver 26 and the light time of flight measurement units 30. By means of the selection unit 32, variably determined avalanche photodiode elements 28 or pixels are connected to a respective time of flight light measuring unit 30. The connection between avalanche photodiode elements 28 and time of flight light measurement units 30 may be 1:1 or n:1. The selection determines active pixels that contribute to the measurement. Unselected pixels, whose signal would not be read out anyway, may be turned off, for example by lowering the bias voltage below the breakdown voltage.

The individual light times of flight determined by light time of flight measuring units 30 are collected in a memory 34, preferably in the form of histograms. The light time of flight measurement units 30 are assigned to one or more groups, and each group generates its own histogram. Via this assignment into groups, the pixels associated with the light time of flight measurement units 30 form multiple measurement areas (ROI, region of interest), with which multiple distance values can be determined simultaneously.

A histogram has n supporting points or bins that divide the time measurement range and thus the range of the sensor 10 or a selected sub-range thereof, forming the uniqueness range of the measurement. The number of bins preferably corresponds to the numerical range, and the bin width corresponds to the time resolution of the light time of flight measuring units 30. In the bins, it is counted how often an individual light time of flight corresponding to the bin has been measured. Contributing to this statistic are, on the one hand, a plurality of light time of flight measurement units 30 associated with the same group and, on the other hand, repeated measurements. The maximum count value or histogram height is determined by the bit depth of the memory cells of the memory 34. For example, 1,024 memory cells having a depth of ten bits may be provided.

If there is only one measurement range (ROI), i.e. if all the individual light times of flight of all the time of flight measurement units 30 are collected in one histogram, the maximum time resolution and smallest bin width are achieved. In the case of multiple measurement ranges, the available memory cells are distributed over multiple histograms, so that the bin width is increased and thus the time resolution is reduced, or the uniqueness range of the measurements is reduced. The partitioning of memory 34 for multiple histograms by intelligent addressing is discussed in more detail below with reference to FIGS. 2 to 5.

Regardless of whether a single histogram or multiple histograms are collected in the memory 34, it always is the same, single and uniform memory having one, single address space, or the same one, single functional block, for example generated by a memory compiler. There is no physical partitioning with associated memory logic. Rather, a read-dressing unit 36 provides, in a manner also still to be explained, that the light time of flight measuring units 30 store their individual light times of flight at addresses of the one, single memory 34, where the assignment of the respective time of flight measuring unit 30 to a group and thus to a measuring range can be reconstructed from the address.

A control and evaluation unit 38 processes the histograms and, for example, searches for a peak caused by the remitted light signal 22. The light time of flight associated with the peak corresponds to the desired distance value, after conversion via the speed of light into customary units. The control and evaluation unit 38 may also be responsible for the other control tasks in the sensor 10 and may be connected to other sensor components for this purpose.

At least some or parts of the light time of flight measurement units 30, the selection unit 32, the memory 34, the readdressing unit 36 and/or the control and evaluation unit 38 may also be integrated with the avalanche photodiode elements 28 on a common chip (e.g. ASIC, Application-Specific Integrated Circuit). It is also conceivable, for example, to accommodate the control and evaluation unit 38 on an additional component, for example a microprocessor, or to implement the readdressing unit 36 in the control and evaluation unit 38.

The arrangement of the sensor 10 in FIG. 1 is to be understood as purely exemplary. Alternatively, other known optical solutions can be used, such as autocollimation with a beam splitter and common optics, or the arrangement of the light transmitter 12 in front of the light receiver 26. More complex sensors such as light grids or laser scanners are also conceivable.

FIG. 2 illustrates a possible general processing sequence of the measurement. After the start of the measurement, the light signal 16 is transmitted and received again within the actual measurement, and the light time of flight measuring units 30 determine individual light times of flight based on the signals from the connected avalanche photodiode elements 28. As soon as the measurement is finished, a flag MEAS_RDY is set, and the k individual light times of flight can be transferred to the memory 34. Preferably, this process is then repeated I more times, for example 1,000 times, to generate a better statistical database through measurement repetition.

FIG. 3 shows an exemplary assignment of measuring ranges 40a-d (ROIs) to time of flight measuring units 30. Here, four measuring ranges 40ad are provided as an example, which can be understood as a subdivision of the light receiver 26 into quadrants. Each of the measurement areas 40a-d is intended to simultaneously provide its own distance value and is connected to a different set of light time of flight light measurement units 30 for this purpose. In the example, there are a total of sixteen time of flight measurement units 30, here in the form of TDCs, and there is a first measurement range 40a associated with TDC1 . . . 4, a second measurement range 40b associated with TDC5 . . . 8, a third measurement range 40c associated with TDC9-12, and a fourth measurement range 40d associated with TDC13-16. It should be noted that two types of mappings are distinguished. On the one hand, certain pixels or avalanche photodiode elements 28 are associated with certain time of flight measurement units 30 by means of the selection unit 32, here 1:1, or alternatively n:1. On the other hand, time of flight measurement units 30 form groups corresponding to measurement areas 40a-d.

FIG. 4 shows the memory 34 divided according to the four measurement areas 40a-d or quadrants and storing four histograms. It should be remembered that the memory 34 physically is a single, non-partitioned memory, which is constructed and addressed in particular like a usual RAM. Consequently, there are memory cells with addresses 0 . . . 2ⁿ−1 at each of which a value can be stored. In a histogram, this value is used as a counter.

In order to store multiple histograms in the memory, multiple address areas are distinguished, in the example four address areas 34a-d corresponding to the four measuring areas 40a-d. The readdressing unit 36 ensures that individual light times of flight are stored in the correct address area 34a-d depending on the generating light time of flight measuring unit 30.

A corresponding address coding is shown on the right side of FIG. 4. Some address bits, in this case the two most significant bits (MSB), are repurposed and no longer code for a bin, but for the group. These address bits and memory cells are then missing in the individual histogram, which accordingly loses time resolution.

Specifically, referring back to the example of FIG. 3, sixteen TDCs are used and connected to four measuring ranges 40a-d designated ROI1 . . . 4. The coding for this is as shown in FIG. 4, for example:

ROI1: TDC1 . . . 4 coded with MSB 00

ROI2: TDC5 . . . 8 coded with MSB 01

ROI3: TDC9 . . . 12 coded with MSB 10

ROI4: TDC13 . . . 16 coded with MSB 11.

In the measurement process sequence of FIG. 2, the storing of the individual light time of flights takes place as soon as the flag MEAS_RDY=1 is set after the transmission of a light signal 16 and a measurement time of, for example, 100 ns for a range of about 15 m. The individual light times of flight are then successively written to the memory 34 by the TDCs1 . . . 16, i.e. the bin determined in each case by the measured individual light times of flight is incremented. The correct MSB addressing and thus selection of the suitable address areas 34a-d is performed, for example, by a state machine of the read-dressing unit 36.

By using this form of histogram partitioning, the sensor 10 provides the option to collect multiple histograms from multiple measurement ranges 40a-d and thus to measure multiple distance values simultaneously. The number of measurement ranges 40a-d can be changed, either by initial configuration or dynamically while already in operation, by reallocating or repurposing more or fewer address bits. A respective doubling of the number of measurement ranges 40a-d causes a halving of the time resolution or, alternatively, the uniqueness range or the range of the measurement. The memory 34 remains uniform and physically one, single memory.

Moreover, reducing the range, in case that the reduced address range 34a-d is compensated for in this way, does not only have disadvantages because it also reduces the measurement times, and the sensor 10 thus has an improved response time. For example, a range of 15 m is measured with one measuring range, a range of 7.5 m is measured with two measuring ranges and a range of 3.8 m is measured with four measuring ranges. At the same time, the measuring time is reduced from 100 ns to 50 ns or 25 ns. This offers convenient flexibility for a wide range of applications. Short response times are advantageous, for example, for four-quadrant recording in motion detection and generation of motion vectors.

For example, if there is a total number of 1,024 memory cells available in the memory 34, and there are sixteen TDCs, to stick with example, this may be used to store

1 ROI with 1×16 TDCs to 1024×10 bits,

2 ROIs with 2×8 TDCs to 2×512×10 bits or

4 ROIs with 4×4 TDCs to 4×256×10 bits.

If more than just the two highest or most significant address bits are repurposed, even more histograms and thus measuring ranges are possible.

FIG. 5 shows an exemplary architecture for the light time of flight measurement units 30, the readdressing unit 36, and the memory 34. In a preferred implementation, the time range of the TDCs just corresponds to the histogram width. Thus, if a TDC measures with 10 bits, a histogram memory with an address range of 10 bits is available. The measurement result of the TDC can then directly be used as an address in the memory 34 and increment the appropriate bin. This describes the situation when only one histogram is to be recorded.

In the case of multiple histograms, all bins are no longer available for a single histogram, the MSB or MSBs are repurposed and encode the assignment of a group or a measurement range (ROI). The repurposed bits are set by the readdressing unit 36 from the identity of the respective TDC that measured the individual light time of flight and, for example, an internal mapping table of TDCs to histograms and thus measurement ranges 40a-d to address ranges 34a-d.

If the reduced memory available per histogram is compensated by a reduction of the range, the MSBs of the TDCs have become free anyway, since only shorter individual light times of flight are measured, which the TDC represents without using the MSBs. Originally, therefore, a TDC only provides the value zero in the MSBs anyway, and the readdressing unit 36 may instead substitute the MSB code for the appropriate measurement range.

Alternatively, the range can be preserved and the timing resolution reduced. This effectively omits from the TDCs the lowest significant bits (LSB, Least Significant Bit) which contribute the finest part of the timing measurement. The readdressing unit 36 shifts the bit pattern by which a TDC represents the measured individual light time of flight to the right by a number s of bits corresponding to the number 2^{s} of histograms, so that the LSBs are dropped out and the MSBs are freed up, which are then replaced by the MSB code for the appropriate measurement range. The control and evaluation unit must then of course work with a bin width extended by a factor of 2^{s}, which is again the time resolution loss. A reduction of range and time resolution can also be combined, thus dividing the loss between the two quantities.

The specific implementation, where the LSBs are disregarded or the range is reduced, is conceivable in many ways. In one example, the TDCs have 12 bits and measure the value TDC_DATA[11:0] with a basic accuracy of 50 ps, and address 10 bits in the histogram. Then either TDC_DATA[9:0] is tapped to actually obtain the highest time resolution of 50 ps, only over a distance range of 7.5 m, or by tapping TDC_DATA[10:1] or TDC_DATA[11:2], the distance range is doubled or quadrupled, and accordingly the time resolution is halved or quartered. A corresponding data tap can also be used to select distance ranges. For example, TDC_DATA[0:9] is tapped at the highest resolution, and the two MSBs TDC_DATA[11:10] are used for an assignment to a distance range, for example in this form:

TDC_DATA[11:10]=b′00==>0 . . . 7.5 m,

TDC_DATA[11:10]=b′01 ==>7.7 . . . 15 m,

TDC_DATA[11:10]=b′10==>15 . . . 22.5 m,

TDC_DATA[11:10]=b′11==>22.5 . . . 30 m.

1. An optoelectronic sensor for measuring a distance of an object in a detection area using a light time of flight method, the sensor comprising
a light transmitter for transmitting a light signal into the detection area,
a light receiver having a first plurality of light receiving elements for detecting received light from the detection area,
a second plurality of light time of flight measuring units for determining respective individual light times of flight from a light time of flight between transmission of the light signal and reception of the light signal remitted or reflected at the object,
a memory for collecting individual light times of flight,
and a control and evaluation unit configured to determine a distance value by evaluating the collected individual light times of flight, including the possibility to determine at least two distance values from the individual light times of flight of at least two groups of light time of flight measuring units,
wherein the sensor comprises a readdressing unit configured to write individual light times of flight to specific addresses of a same uniform memory depending on the assignment of a light time of flight measuring unit to a group, so that the control and evaluation unit can assign the stored individual light times of flight via the address to a group and thus to a distance value.

2. The sensor according to claim 1,
wherein the control and evaluation unit is configured to change the number of groups.

3. The sensor according to claim 1,
comprising a selection unit configured to variably connect light time of flight units to light receiving elements.

4. The sensor according to claim 1,
wherein the memory is configured so that a discrete function can be stored therein in memory cells with successive addresses, and individual light times of flight can be stored therein and retrieved in this way.

5. The sensor according to claim 4,
wherein the addresses of the memory cells correspond to the definition range and the associated function values are stored in the memory cells.

6. The sensor according to claim 1,
wherein the readdressing unit is configured to use at least one address bit of an address for assignment to a group.

7. The sensor according to claim 6,
wherein the address bit is the most significant bit or the address bits are the most significant bits.

8. The sensor according to claim 1,
wherein the memory is configured as a histogram memory and the individual light times of flight are collected in at least one histogram.

9. The sensor according to claim 8,
wherein the histogram memory comprises as many memory cells as bins of a histogram for only one group.

10. The sensor according to claim 1,
wherein the readdressing unit is configured to encode the group in at least one bit of the addresses and a respective bin of a histogram in the remaining bits of the addresses.

11. The sensor according to claim 10,
wherein the readdressing unit is configured to encode the group in the most significant bit or bits.

12. The sensor according to claim 1,
wherein the light receiving elements each comprise an avalanche photodiode biased with a bias voltage above a breakdown voltage and thus operated in a Geiger mode.

13. The sensor according to claim 1,
wherein the light time of flight measuring units comprise a TDC.

14. A method for a distance measurement of an object in a detection area using a light time of flight method,
wherein a light signal is transmitted into the detection area and the light signal reflected or remitted in the detection area is detected by a light receiver having a first plurality of light receiving elements,
wherein respective individual light times of flight are measured with a second plurality of light time of flight measuring units from a light time of flight between transmitting the light signal and receiving the light signal remitted or reflected at the object,
the individual light times of flight are collected in a memory,
and at least two distance values are determined from the individual light times of flight of at least two groups of light time of flight measuring units,
wherein individual light times of flight are written to specific addresses of the same uniform memory depending on the assignment of a light time of flight measuring unit to a group and, when distance values are determined, the stored individual light times of flight are assigned via the address to a group and thus to a distance value.
